(19) United States
(12) Patent Application Publication
(10) Pub. No.: US 2026/0080346 A1
(43) Pub. Date: Mar. 19, 2026

(54) System, Method and Computer-Readable Medium for Organizational Redesign Through Analysis and Phased Implementation Based on User Input and Current Models

(71) Applicant: TEACHERS INSURANCE AND ANNUITY ASSOCIATION OF AMERICA, New York, NY (US)

(72) Inventors: Sastry VSM Durvasula, Phoenix, AZ (US); Swatee Singh, Livingston, NJ (US); Rares Ioan Almasan, Paradise Valley, AZ (US); Sonam Jha, Skillman, NJ (US); Sriram Venkatesan, Princeton Junction, AZ (US); Thomas Matthew Verutes, Rockville Centre, NY (US)

(21) Appl. No.: 18/885,469

(22) Filed: Sep. 13, 2024

(51) Int. Cl. G06Q 10/067

(52) U.S. Cl. CPC G06Q 10/067

(57) ABSTRACT

A computing system includes a processor and memory with instructions to receive user input on redesign objectives, analyze organizational models, generate recommendations for organizational maturity, and output a redesign plan. A method involves receiving user input on redesign objectives, analyzing organizational models, generating recommendations for organizational maturity, and outputting a redesign plan. A computer-readable medium has instructions for receiving user input on redesign objectives, analyzing organizational models, generating recommendations, and outputting a redesign plan.

### FIELD OF THE INVENTION

The present aspects relate to computing systems and methods for organizational redesign, and more particularly, to systems, methods, and mediums that facilitate the analysis of current organizational models and the generation of secure, lean, scalable redesign plans that meet customer needs, such as using generative AI models to map user inputs to specific redesign scenarios.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Organizational restructuring, commonly referred to as reorganization or “reorg,” is a critical process for businesses aiming to maintain competitiveness and adaptability in a rapidly changing technological landscape. Traditionally, this process requires a comprehensive analysis of the current state of the organization, including its technology, processes, and human resources. This analysis is often time-consuming and complex, necessitating deep expertise across different domains and significant collaboration among various functions within the organization. Moreover, synthesizing the gathered information to design a coherent and effective reorg plan adds another layer of complexity and potential for inefficiency.

Current methodologies for conducting reorgs demand considerable time and introduce the risk of human error, potentially leading to suboptimal organizational designs. Furthermore, the need to comply with industry-specific regulations and regional policies adds another dimension of complexity to the reorg process. Ensuring that the redesigned organization remains lean, scalable, secure, and aligned with customer needs while also adhering to relevant policies requires a nuanced understanding of both the internal and external factors affecting the organization.

Given these challenges, there are opportunities for improved platforms and technologies that can streamline the reorg process, making it more efficient, accurate, and responsive to the evolving demands of the business environment.

### BRIEF SUMMARY OF THE INVENTION

In one aspect, a computing system includes: (1) a processor; and (2) a memory that includes computer-executable instructions that, when executed, cause the computing system to: receive user input regarding organizational redesign objectives and parameters; analyze current organizational models including people, process, and technology landscapes; generate recommendations for organizational maturity and design future state ecosystems that are secure, lean, scalable, and meet customer needs; and output a redesign plan for the organization in a phased approach based on the analysis and recommendations.

In another aspect, a computer-implemented method includes: (1) receiving user input regarding organizational redesign objectives and parameters; (2) analyzing current organizational models including people, process, and technology landscapes; (3) generating recommendations for organizational maturity and design future state ecosystems that are secure, lean, scalable, and meet customer needs; and (4) outputting a redesign plan for the organization in a phased approach based on the analysis and recommendations.

In yet another aspect, a computer-readable medium includes instructions that, when executed, cause a computer to: (1) receive user input regarding organizational redesign objectives and parameters; (2) analyze current organizational models including people, process, and technology landscapes; (3) generate recommendations for organizational maturity and design future state ecosystems that are secure, lean, scalable, and meet customer needs; and (4) output a redesign plan for the organization in a phased approach based on the analysis and recommendations.

Advantages will become more apparent to those of ordinary skill in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

Advantages will become more apparent to those of ordinary skill in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof.

There are shown in the drawings arrangements which are presently discussed, it being understood, however, that the present embodiments are not limited to the precise arrangements and instrumentalities shown, wherein:

FIG. 1 depicts a computing environment for managing and supporting organizational redesign processes through the integration of various organizational landscapes and knowledge areas using artificial intelligence, according to some aspects.

FIG. 2 depicts a block flow diagram of an AI-enabled org redesigner system for managing and supporting organizational redesign processes, with a focus on integrating input from different organizational landscapes and knowledge areas through an intelligent designer to facilitate the org redesign, according to some aspects.

FIG. 3 depicts block flow diagram corresponding to the system of FIG. 2, according to some aspects.

FIG. 3 depicts block flow diagram corresponding to the system of FIG. 2, according to some aspects.

FIG. 4 depicts block flow diagram corresponding to the system of FIG. 2, according to some aspects.

FIG. 5 depicts block flow diagram corresponding to the system of FIG. 2, according to some aspects.

FIG. 6 depicts block flow diagram corresponding to the system of FIG. 2, according to some aspects.

FIG. 7 depicts block flow diagram corresponding to the system of FIG. 2, according to some aspects.

FIG. 8 depicts block flow diagram corresponding to the system of FIG. 2, according to some aspects.

FIG. 9 depicts block flow diagram corresponding to the system of FIG. 2, according to some aspects.

FIG. 10 depicts block flow diagram corresponding to the system of FIG. 2, according to some aspects.

FIG. 11 depicts a computer-implemented method for machine learning training, according to some aspects.

FIG. 12A depicts a block-flow diagram of a method and system designed to facilitate organizational redesign through analysis and phased implementation based on user input and current models.

FIG. 12B illustrates a transformer-based model architecture for processing tokenized training text, according to some aspects.

### DETAILED DESCRIPTION

The disclosed system and model may perform organizational redesign, specifically tailored to prepare organizations for optimized technology ecosystems. This system may include AI-driven methodology that addresses the complex and time-consuming process of organizational restructuring. The present techniques may leverage a deep understanding of the current state of an organization's people, processes, and technology landscapes to identify areas of opportunity and design a future state ecosystem that is secure, lean, scalable, and aligned with customer needs. The system's capability to measure the maturity of the existing system and generate recommendations for enhancement sets it apart from traditional methods.

One of the significant challenges in organizational redesign is the complexity and time required to analyze the current state comprehensively, including technology, people, and processes, and to envision a target state that meets the organization's objectives. This process demands expertise across various domains, collaboration among different functions, and a considerable amount of time to synthesize information and formulate a reorganization plan. No one single person or team of people possesses the global view necessary to carry out this analysis. The disclosed system addresses these challenges by automating the data collection and analysis process, an organization-wide redesign process to occur. In some aspects, this automation may be achieved through the use of generative AI models that synthesize inputs from various sources, including user inputs, to map out the organization's current state and generate recommendations for its future state.

The system improves the processing capabilities of computers by leveraging AI to analyze vast amounts of data related to the organization's current state and potential future states. This analysis includes understanding the people landscape, process landscape, and technology landscape, thereby enabling a comprehensive and nuanced approach to organizational redesign. Secondly, the system optimizes network usage by intelligently sourcing and synthesizing information from various internal and external sources, including industry-specific knowledge and region-specific regulations. This ensures that the redesign is not only effective but also compliant with relevant standards and regulations. The present techniques employ a chatbot-enabled platform to interact with users, collecting detailed inputs regarding organizational redesign objectives and parameters. This interaction model minimizes unnecessary data transmission over the network, as the chatbot can intelligently filter and request only the relevant information from users. Furthermore, the use of generative AI models to synthesize and map user inputs to specific redesign scenarios further optimizes data flow within the system, ensuring that network resources are used efficiently. Lastly, the system improves memory usage by efficiently managing and storing data related to the organization's current state and the proposed future state designs. This includes storing user inputs, HR documents, process documents, and technical requirement documents, among others, in a structured manner that facilitates easy access and analysis.

The system's design is inherently flexible and scalable, allowing for customization based on user inputs and specific organizational goals. Whether the organization opts for a phased approach or a direct overhaul of its structure, the system provides tailored recommendations that consider the unique aspects of the organization's current state and its future objectives. This user-centric approach, combined with the system's AI-driven analysis and recommendations, ensures that the organizational redesign is both strategic and aligned with the organization's long-term vision.

In summary, the disclosed system represents a significant advancement in the field of organizational redesign. By automating the analysis of the current state and generating AI-driven recommendations for the future state, the system not only simplifies the redesign process but also ensures that the proposed changes are strategic, data-driven, and aligned with the organization's objectives. This approach not only addresses the technical challenges associated with organizational redesign but also offers a scalable and flexible solution that can adapt to the unique needs of any organization, regardless of its industry or geographic location.

As noted, by focusing on the interplay between people, processes, and technology landscapes, the present techniques offer a methodical approach to organizational redesign that is both secure and scalable, ensuring that the redesigned organization meets customer needs effectively. The present techniques also avoid biases that may creep into conventional organizational reorg processes.

In summary, the present techniques offer a transformative approach to organizational redesign, leveraging the power of computing systems and AI to improve processing efficiency, optimize network and memory usage, and deliver secure, lean, and scalable future state ecosystems. These improvements address the technical problem of the time-consuming and complex nature of traditional reorganization processes, providing a solution that is both efficient and effective in meeting the evolving needs of organizations.

### Exemplary Computing System

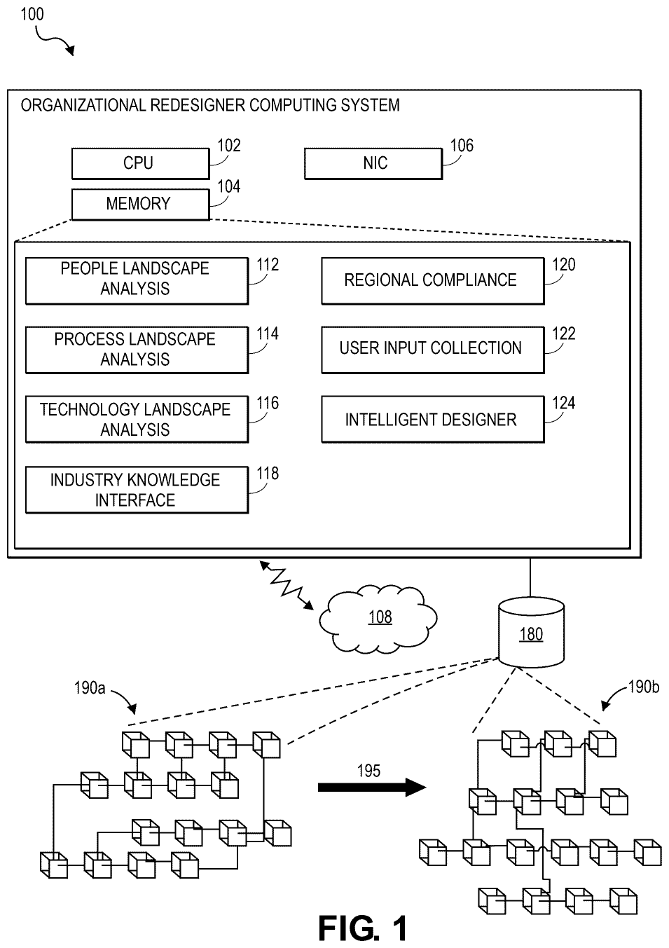

FIG. 1 depicts a computing environment for managing and supporting organizational redesign processes through the integration of various organizational landscapes and knowledge areas using artificial intelligence, according to some aspects. The computing environment includes an organizational redesigner computing system 100. The system 100 includes a processor 102, a memory 104, and a network interface controller (NIC) 106. The organizational redesigner computing system 100 is designed to receive inputs about the current people, process, and technology landscapes of an organization, interface with industry knowledge and regional rules and policies, and receive user input including requirements, preferences, or feedback for organizational redesign. By employing an intelligent designer, the system synthesizes these inputs to generate an organizational redesign that includes recommendations for process design, changes in people structure, job descriptions, compensation documents, and architecture design documents.

In some aspects, the processor 102 may include any number of processors and/or processor types, such as central processing units (CPUs), graphics processing units (GPUs), and others. Generally, the processor is configured to execute software instructions stored in the memory 104. The memory 104 may include non-transitory, volatile and/or non-volatile fixed and/or removable memory, such as random access memory (RAM), read-only memory (ROM), and others. The memory 104 has stored thereon one or more sets of computer-executable instructions.

The memory 104 includes a plurality of modules, each including a respective set of computer-executable instructions. For example, a people landscape analysis module 112 analyzes the current people landscape of an organization, leveraging existing people ecosystem information, organization charts, HR documents, and compensation documents. A process landscape analysis module 114 leverages existing process documents, SOPs, user flow documents, business, and functional requirement documents to identify efficiency opportunities and gaps in the process landscape. A technology landscape analysis module 116 provides information about the tech ecosystem, leveraging technical requirement documents, runbooks, playbooks, and code repositories. An industry knowledge interface module 118 interfaces with industry knowledge, gathering information from the web, past documents, and industry domain documents. A regional compliance module 120 consolidates region-specific information about policies, rules, and regulations. A user input collection module 122 collects user input through an interactive chatbot-enabled platform. An intelligent designer module 124 synthesizes all the inputs, industry knowledge, regional rules and policies, and user input to craft the organizational redesign.

The NIC 106 includes any suitable network interface controller(s), facilitating bidirectional networking over the network between the organizational redesigner computing system 100 and external data sources, industry knowledge bases, regulatory databases, and user interfaces. The network may be a single communication network or may include multiple communication networks of one or more types, such as wired and/or wireless local area networks (LANs), and/or wide area networks (WANs) such as the Internet.

The system 100 may include an electronic database 180. The database 180 may store and manage the data required for the organizational redesign process. This database may hold inputs about the organization's current state, including details on the people, process, and technology landscapes, as well as industry knowledge, regional rules and policies, and user inputs. The database facilitates efficient access, retrieval, and analysis of data, enabling the system to synthesize these inputs and craft a comprehensive organizational redesign.

In some aspects, the database 180 may include a relational database that organizes data such as organization charts, HR documents, process documents, and technical requirement documents. In some aspects, the database 180 may include a NoSQL databases that stores data such as user inputs collected through chatbots, industry knowledge from the web, and unstructured documents. In some aspects, the database 180 may include a graph database, for example, that stores relationships within an organization, such as the connections between different roles, processes, and technology systems.

In operation, the organizational redesigner computing system 100 begins by gathering inputs about the organization's current state, including the people, process, and technology landscapes. It interfaces with industry knowledge and regional rules and policies to ensure that the redesign is both industry-agnostic and compliant with regulatory requirements. User input is collected to understand objectives, goals, and key parameters for the redesign. The intelligent designer module 124 synthesizes all collected inputs to craft the organizational redesign, employing Generative AI models to synthesize and map user inputs to scenarios needed for redesigning the organization. The system employs a continuous learning model with human in the loop for ongoing improvement, ensuring that the redesign remains relevant and effective over time. The output of the system includes process design documents, changes in people structure, job descriptions, compensation documents, and architecture design documents, providing a detailed overview of the redesigned organization, including a new org chart with updated roles and responsibilities.

The system 100 may include transforming an organization's state using machine learning. For example, the system 100 depicts an input organizational object 190a, which represents the current state of an organization, including its structure, processes, and technology landscape. This input object may be a data model that encapsulates various aspects of the organization, such as roles, hierarchies, workflows, and technological infrastructure. The process of transforming input organizational object 190a into an output organizational object 190b, which represents the redesigned organization may include processing the object 190a using a trained machine learning model 195. In addition to generating the object 190b, the system 100 may generate a detailed redesign recommendation report that outlines the recommended changes in processes, people structure, and technology landscape. This report may include justifications for the recommendations and explanations of the proposed changes. The system 100 may also output a new organizational chart that reflects the redesigned structure, including updated roles, responsibilities, and reporting lines. The system 100 may automate the generation of hiring and onboarding documents based on the redesigned organizational structure. This automation extends to job descriptions, compensation documents, and other HR-related materials, streamlining the hiring process. The system 100 may generate architecture design documents corresponding to the technology landscape. For example, the system 100 may generate detailed architecture design documents that outline the future tech stack, software tools, licensing requirements, and the overall technological framework of the redesigned organization. Training of the machine learning model 195 is described further below.

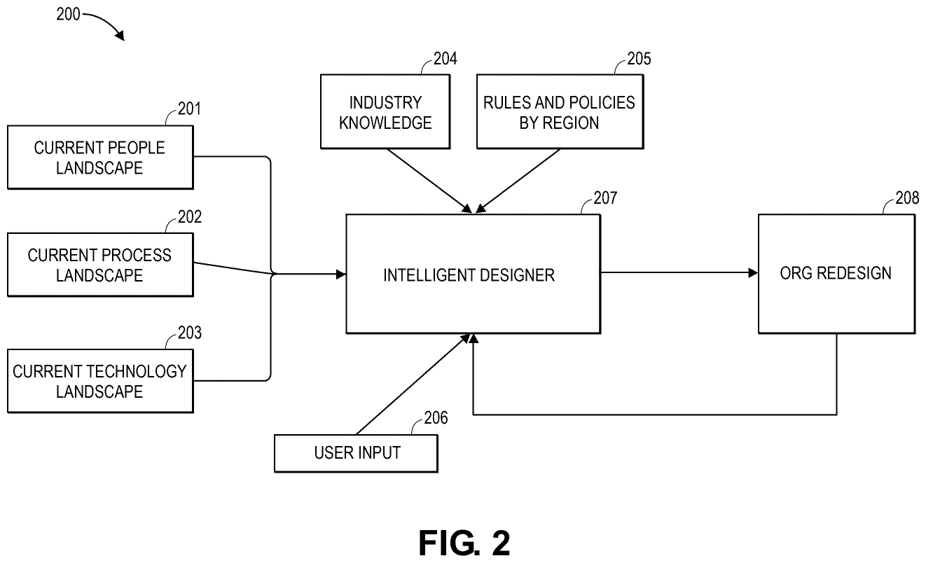

The system 100 may first retrieve the input organizational object 190a from database 180, where organizational data is stored. Once retrieved, the system 100 may preprocess the data to ensure it is in a suitable format for analysis. Preprocessing may include cleaning the data, normalizing data formats, and extracting relevant features that will be used by the machine learning model 195. Next, the preprocessed data may be passed through various analysis modules within the memory 104, such as the people landscape analysis module 112, process landscape analysis module 114, and technology landscape analysis module 116. Each module may specific analytical techniques to understand the current state of the organization's people, processes, and technology. This step may involve identifying inefficiencies, gaps, and opportunities for optimization within the current organizational structure. The modules 112, 114 and 116 are described further below, with respect to FIG. 2. The insights generated by the analysis modules may be fed into the trained machine learning model 195, which is part of the intelligent designer module 124. By this point, the model may have been previously trained on a dataset of organizational redesigns, learning patterns, and strategies that have led to successful outcomes. The model may apply this learned knowledge to the input organizational object 190a, processing the data to identify one or more redesign strategies. This may involve recommending changes to the organizational structure, processes, and technology deployment to enhance efficiency, agility, and compliance; and/or to maintain organizational/stakeholder objectives, as discussed below.

Based on the recommendations of the machine learning model 195, the system generates the output organizational object 190b. This object represents the proposed redesigned organization, including a new org chart with updated roles and responsibilities, optimized processes, and a revised technology landscape. The output object is a blueprint for the redesigned organization, detailing the changes needed to achieve the desired outcomes.

The output organizational object 190b may be reviewed by stakeholders, in some cases through an interactive platform facilitated by the user input collection module 122. Feedback from stakeholders can be incorporated back into the system, and the machine learning model 195 can further refine the redesign based on this feedback. This iterative process ensures that the final organizational redesign aligns with stakeholder preferences and organizational goals.

### Exemplary AI-enabled Organizational Redesigner Computing System

FIG. 2 depicts a block flow diagram of an AI-enabled org redesigner system 200 for managing and supporting organizational redesign processes, with a focus on integrating input from different organizational landscapes and knowledge areas through an intelligent designer to facilitate the org redesign, according to some aspects.

The org redesigner system 200 receives input about the current people landscape (block 201), current process landscape (block 202), and current technology landscape (block 203). These inputs represent foundational aspects of the organization that will inform the redesign process, that may be generated automatically (e.g., via machine learning, database queries, etc.) and/or fed using manual inputs (e.g., via user-collected/curated data).

For understanding the current people landscape at block 201, the org redesigner system 200 may leverage existing people ecosystem information, organization charts, HR documents, and compensation documents to identify future reorg needs, skill sets, and roles. The org redesigner system 200 may classify and organize by roles, creating a technical layout for use in the redesign process.

For understanding the current process landscape at block 202, the org redesigner system 200 may leverage existing process documents, SOPs, user flow documents, business, and functional requirement documents. This enables the org redesigner system 200 to identify efficiency opportunities and gaps for future design. Similar to the people landscape, the org redesigner system 200 may classify and map data at block 202 based on specific processes.

For understanding the current technology landscape at block 203, the org redesigner system 200 may provide information about the tech ecosystem, leveraging technical requirement documents, runbooks, playbooks, and code repositories to understand the current tech stack and architecture. The org redesigner system 200 may classify this information by specific applications or systems.

The org redesigner system 200 may also interface with industry knowledge (block 204) and rules & policies by region (block 205), which provide further context and constraints for the organizational redesign. The data provided by blocks 204 and 205 may help to ensure that the redesign process considers industry-specific insights and complies with regional regulatory requirements. For example, at block 204, the org redesigner system 200 may gather industry knowledge from the web, past documents, and industry domain documents, classified based on the industry to use specific industry knowledge in the redesign. This approach ensures the redesign is industry-agnostic, incorporating regulatory requirements and practices specific to each industry. Further, at block 205, the org redesigner system 200 may consolidate region-specific information about policies, rules, and regulations to ensure compliance with regulatory requirements during the redesign, especially for regions/jurisdictions with specific requirements (e.g., Europe, Asia, etc.).

In addition to these inputs, the AI-enabled org redesigner may include receiving user Input (block 206), which may include one or more requirements, preferences, or feedback from stakeholders involved in the organization's redesign. User Input at block 206 may be collected through an interactive chatbot-enabled platform to understand objectives, goals, and key parameters for the redesign.

The org redesigner system 200 may include an intelligent designer (block 207), which synthesizes all the inputs from blocks 201, 202, 203, 204, 205, and 206. The intelligent designer 207 may employ this collective knowledge to intelligently craft the org redesign. The outcome of this integrative process is an org redesign (block 208), which is the final product of the AI-enabled org redesigner system 200, encapsulating the new organizational design that has been optimized based on the various inputs and the intelligent processing carried out by block 207. The org designer 200 depicts different landscapes and knowledge areas that converge within the intelligent designer 207 to yield a holistic and informed organizational redesign, leveraging AI for synthesis and decision support.

The org redesigner system 200 may perform data collection in an automated way, enabling a few individuals to shape the redesign based on available data. The org redesigner system 200 may use one or more a Generative AI (GenAI) model to synthesize and map user inputs to scenarios needed for redesigning the organization. The org redesigner system 200 may synthesize input information to recommend future patterns and create a detailed redesign recommendation report.

In some aspects, org redesigner system 200 may employ a continuous learning model with human in the loop for ongoing improvement. The output of the org redesigner system 200 may include process design documents, changes in people structure, job descriptions, compensation documents, and/or architecture design documents, providing a comprehensive overview of the redesigned organization, including a new org chart with updated roles and responsibilities.

The individual subcomponents of the org redesigner system 200 will now be discussed in further detail.

### Exemplary AI-enabled Organizational Redesigner System Subcomponents

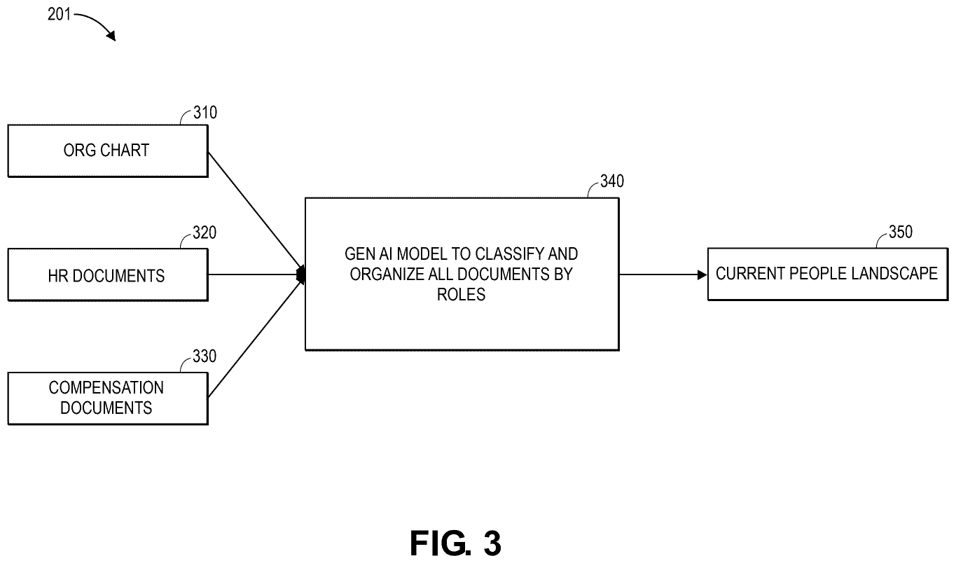

FIG. 3 depicts block flow diagram corresponding to block 201 of FIG. 2, according to some aspects, and showing block 201 in greater detail. Block 201 defines a subprocess of the AI-enabled org redesigner system 200 that understands and organizes the current people landscape. At block 201, the block flow diagram depicts the system 200 method of leveraging existing people ecosystem information to inform the redesign process. This includes receiving organization charts (block 310), HR documents (block 320), and compensation documents (block 330), which respectively identify future reorganization needs, skill sets, and roles. The block 201 may include processing these elements using a generative AI model (block 340) that classifies and organizes the documents by roles, creating a technical layout for use in the organizational redesign.

The output of this generative AI processing may be a current people landscape (block 350) that represents the organized documents by roles, contributing to a clearer understanding of the organization's current personnel structure. Block 201 illustrates the capability of the AI-enabled org redesigner system 200 to synthesize and map user inputs to scenarios needed for redesigning the organization, employing a continuous learning model with human in the loop for ongoing improvement. The output at block 350 may include process design documents, changes in people structure, job descriptions, compensation documents, and architecture design documents, providing a comprehensive overview of the redesigned organization, including a new org chart with updated roles and responsibilities.

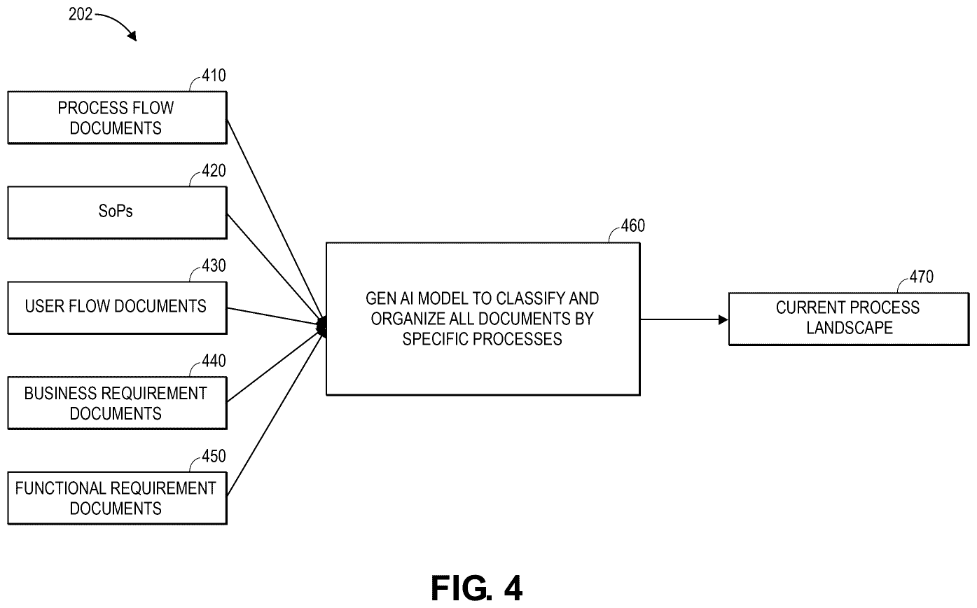

FIG. 4 depicts a block flow diagram corresponding to block 202 of the system 200 of FIG. 2, according to some aspects, and presents block 202 in greater detail. Block 202 outlines a subprocess of the AI-enabled system that understands and organizes current process documents. At block 202, the block flow diagram portrays the method of the system of using various types of process-related documents to feed into an artificial intelligence (AI) model.

Specifically, the diagram includes process flow documents (block 410), SOPs (Standard Operating Procedures) (block 420), user flow documents (block 430), business requirement documents (block 440), and functional requirement documents (block 450). These different types of documents are input into an AI model (block 460) designed to classify and organize all documents by specific processes.

The output of this generative AI processing is depicted as a current process landscape (block 470) that represents the organized documents in relation to specific processes within a business or system, contributing to a better understanding of the organization's current processes. Block 202 illustrates how the AI-enabled system can utilize diverse document inputs for creating a structured overview of the existing business processes, based on both the nature of the documents and their contents. This process facilitates the continuous improvement of the AI model and enhances the overall efficiency and organization of the system's processes.

The diagram of FIG. 4 effectively visualizes the flow from the different document inputs toward the generative AI model, finally culminating in an organized current process landscape. This reflects the system's capability to intelligently classify and systematize complex documentation, thereby allowing for more informed decision-making and optimization of process management.

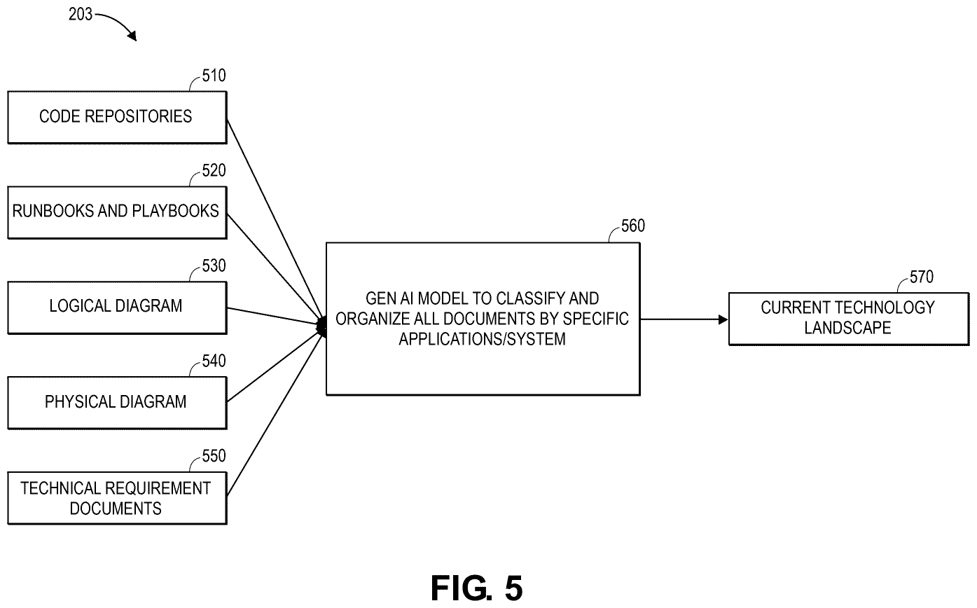

FIG. 5 depicts a block flow diagram corresponding to block 203 of the system 200 of FIG. 2, according to some aspects, and presents block 203 in greater detail. Block 203 delineates a subprocess of the AI-enabled system that classifies and organizes documents by specific applications or systems. At block 203, the block flow diagram exhibits the methodology used by the system to harness various types of documents and feed them into an artificial intelligence (AI) model.

Specifically, the diagram includes code repositories (block 510), runbooks and playbooks (block 520), logical diagrams (block 530), physical diagrams (block 540), and technical requirement documents (block 550). These different types of technical documents serve as inputs into an AI model (block 560) trained to classify and arrange all documents in connection with specific applications or systems.

The output of this AI processing at block 560 is represented as a current technology landscape (block 570), illustrating the organized documents in relation to the specific technology environment within an entity, contributing to a refined comprehension of the organization's current technology structure. Block 203 demonstrates how the AI-enabled system leverages a variety of document inputs to create a coherent picture of the existing technology infrastructure, which is based on the nature of the documents as well as their relevance to the applications or systems. This mechanism enables ongoing refinement of the AI model and bolsters the overall efficiency and structuring of the technology-related documents.

The diagram of FIG. 5 conceptualizes the progression from diverse document inputs toward the generative AI model, concluding with a structured current technology landscape. This illustration underscores the system's proficiency in intelligently categorizing and systemizing intricate documentation, thereby facilitating more strategic decision-making and improvement in the management of the technology framework.

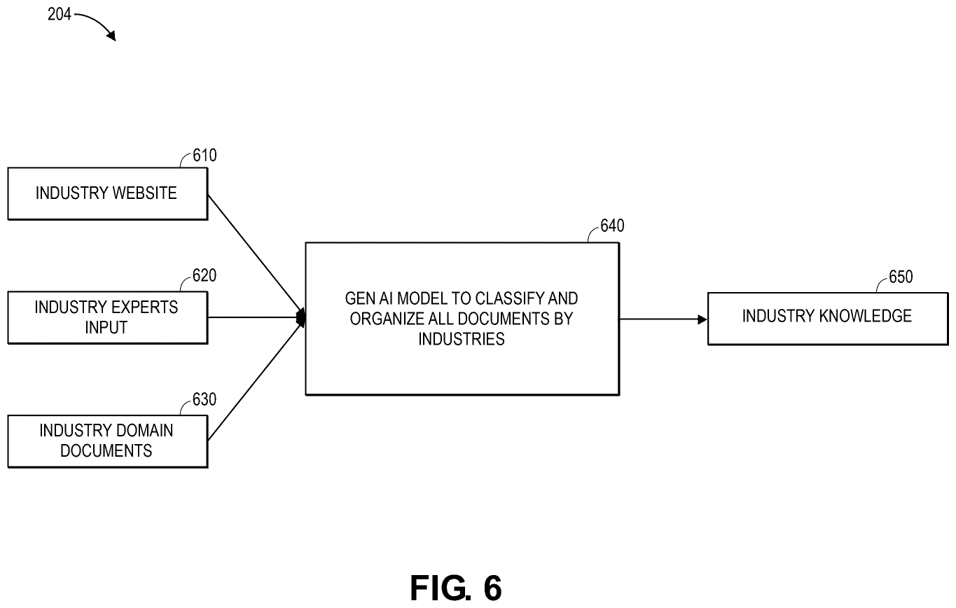

FIG. 6 depicts a block flow diagram corresponding to block 204 of the system 200 of FIG. 2, according to some aspects, and presents block 204 in greater detail. Block 204 delineates a subprocess of the AI-enabled system that classifies and organizes documents by industries. At block 204, the block flow diagram exhibits the methodology used by the system to utilize inputs from various information sources and feed them into an artificial intelligence (AI) model.

Specifically, the diagram includes an ‘Industry Website’ input (block 610), ‘Industry Experts Input’ (block 620), and ‘Industry Domain Documents’ input (block 630). These distinct types of industry-related documents and inputs serve as inputs into a generalized AI model (block 640) trained to classify and arrange all documents in connection with different industries.

The output of this AI processing at block 640 is represented as ‘Industry Knowledge’ (block 650), illustrating the organized documents in accordance with their respective industries. Block 204 demonstrates how the AI-enabled system processes a diverse array of industry information inputs to create a structured body of industry knowledge. This mechanism enables ongoing enhancement of the AI model and strengthens the systematic organization and comprehension of industry-specific documents.

The diagram of FIG. 6 conceptualizes the progression from diverse industry information inputs through the generalized AI model, culminating in a structured body of industry knowledge. This illustration emphasizes the system's capability in intelligently categorizing and organizing complex documentation, thus facilitating better strategic insights and advancements in the management of industry-related knowledge.

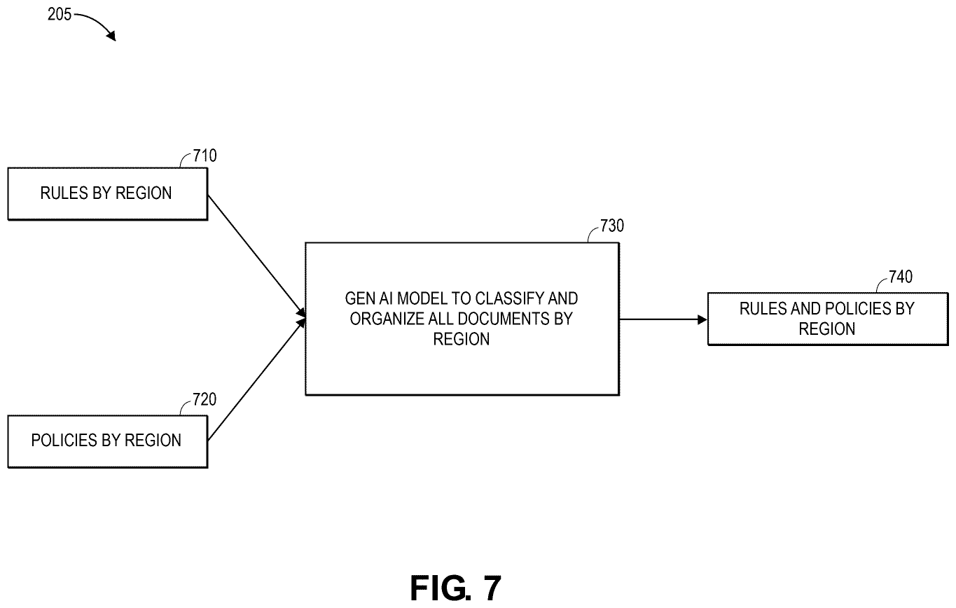

FIG. 7 depicts a block flow diagram corresponding to block 205 of the system 200 of FIG. 2, according to some aspects, and presents block 205 in greater detail. Block 205 delineates a subprocess of the AI-enabled system that classifies and organizes documents by region. At block 205, the block flow diagram exhibits the methodology used by the system to utilize inputs from region-specific rules and policies and feed them into an artificial intelligence (AI) model.

Specifically, the diagram includes a ‘Rules by region’ input (block 710) and ‘Policies by region’ input (block 720). These distinct types of region-related rules and policies serve as inputs into a generative AI model (block 730) trained to classify and organize all documents in accordance with different regions.

The output of this AI processing at block 730 is represented as ‘Rules & Policies by region’ (block 740), illustrating the organized documents in accordance with their respective regions. Block 205 demonstrates how the AI-enabled system processes a diverse array of region-specific rules and policies inputs to create a structured body of region-oriented rules and policies. This mechanism enables ongoing enhancement of the AI model and strengthens the systematic organization and comprehension of region-specific rules and policies.

The diagram of FIG. 7 conceptualizes the progression from distinct regional rules and policies inputs through the generalized AI model, culminating in a structured body of rules and policies by region. This illustration emphasizes the system's capability in intelligently categorizing and organizing complex documentation based on regional distinctions, thus facilitating better strategic insights and advancements in the management of region-specific regulatory information.

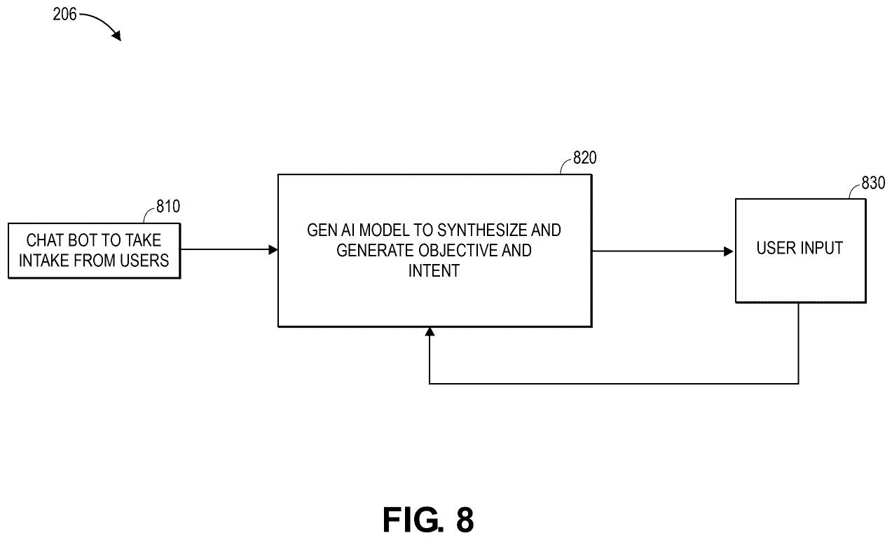

FIG. 8 depicts a block flow diagram corresponding to block 206 of the system 200 of FIG. 2, according to some aspects, and presents block 206 in greater detail. Block 206 delineates a subprocess of the AI-enabled communication system that facilitates interactions with users through a chat interface. The diagram illustrates the internal workflow of how user inputs are processed and synthesized to generate specific objectives and intents within the system.

Specifically, the diagram includes a ‘Chat bot to take intake from users’ (block 810), which serves as the initial point of interaction where the chat bot receives inputs from users. Following that, there is a ‘Gen AI model to synthesize and generate objective and intent’ (block 820) which receives the intake from block 810 and processes the data to understand and generate an objective and intent of the user interaction. The final block displayed is ‘User Input’ (block 830), which represents the manner in which the system takes external input from users.

The output of the AI processing at block 820, is then directed back to the ‘User Input’ block, defining a feedback loop where the synthesized objective and intent may influence or alter subsequent user input. This illustrates how block 206 allows for the dynamic modification and refinement of user interactions based on the synthesized understanding achieved by the generative AI model.

The diagram of FIG. 8 conceptualizes the transition from user interaction with the chat bot, through the generative AI model, resulting in a feedback that refines the objectives and intents of the system's user engagements. This iteration underscores the system's capacity to intelligently interpret and adapt to user inputs, effectively personalizing the communication experience. This is pivotal for the AI communication system's capability in maintaining an interactive dialogue that is responsive to the evolving context of each user interaction.

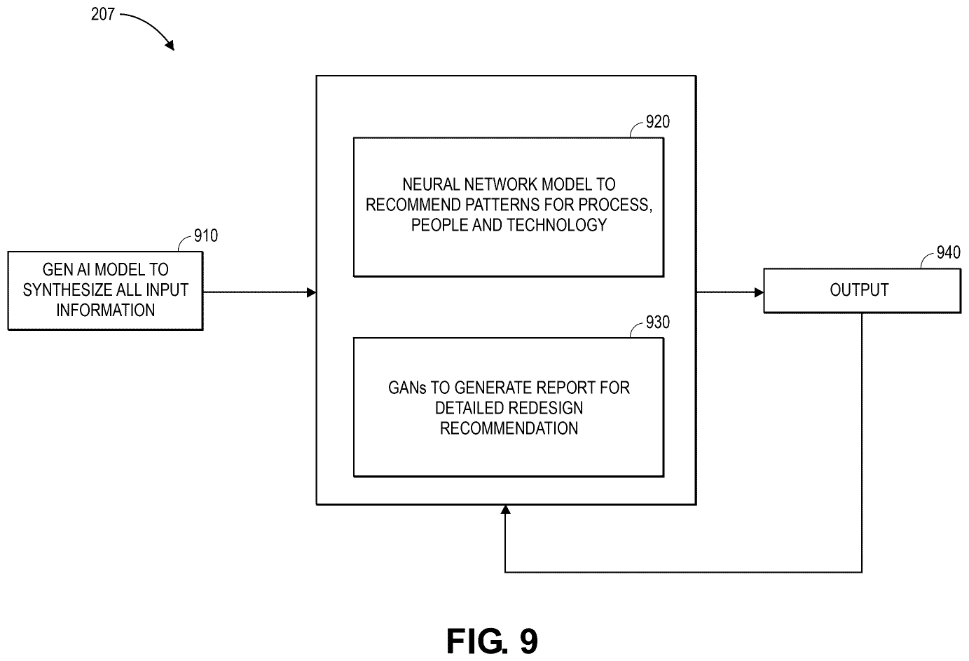

FIG. 9 depicts a block flow diagram corresponding to block 207 of the system 200, according to some aspects, and presents block 207 in greater detail. Block 207 delineates a subprocess of the system that involves the use of artificial intelligence to synthesize input information and generate recommendations for process, people, and technology enhancements.

Specifically, the diagram includes a ‘Gen AI model to synthesize all input information’ (block 910), which serves as the initial processing step where the general AI model synthesizes various forms of input data. Following that, there is a ‘Neural Network model to recommend patterns for process, people and technology’ (block 920) which receives the synthesized input from block 910 and uses it to recommend patterns and strategies that could improve processes, people involvement, and technology use. Additionally, there is a ‘GANs to generate report for detailed redesign recommendation’ (block 930) that takes the output from block 920 and uses Generative Adversarial Networks (GANs) to create a detailed report outlining specific recommendations for redesigning.

The output of the process at block 930 is then directed to an ‘Output’ block (block 940), which represents the final output of the subprocess. The arrangement demonstrates the system's capability to produce applicable and practical recommendations after analyzing the input data through sophisticated AI and neural network models, refining them through GANs for detailed reporting.

The diagram of FIG. 9 conceptualizes the transition from the synthesis of input information through a general AI model, recommendations from a neural network model, to the generation of detailed redesign recommendations via GANs, culminating in a tangible output. This progression exemplifies the system's capacity to intelligently analyze, interpret, and provide solutions for advancing the effectiveness and efficiency of processes, people's roles, and technology deployment. The design underscores the integration of multiple AI methodologies to support decision-making and strategy formulation in a cohesive and structured workflow.

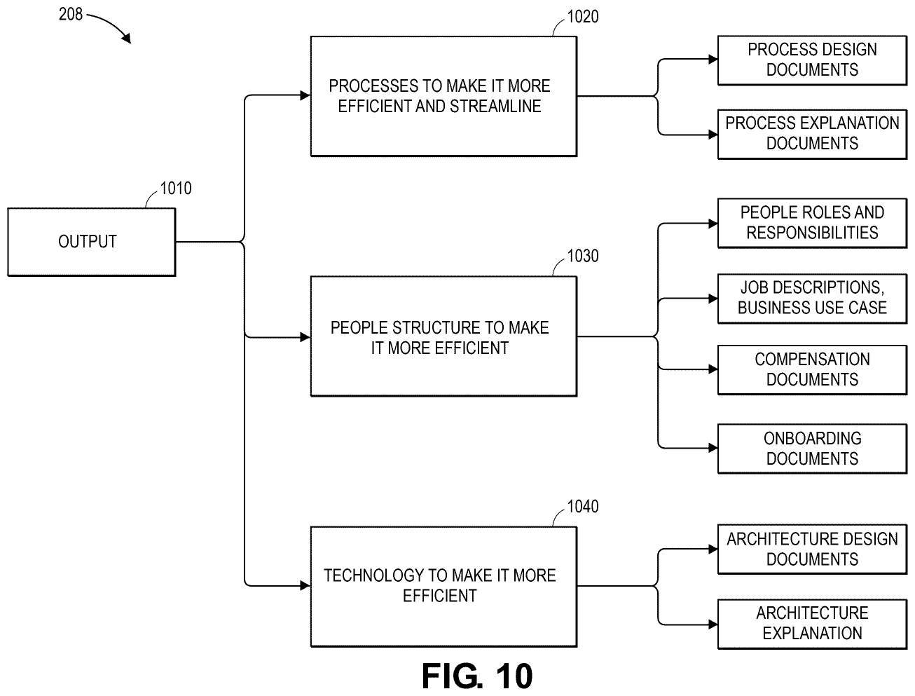

FIG. 10 depicts a block flow diagram corresponding to block 208 of the system 200, expanding on the subprocess related to output 940 of FIG. 9, according to some aspects, and provides a detailed breakdown of the output 1010 in greater detail. Block 208 illustrates the subprocesses involved in enhancing efficiency and streamlining through process, people structure, and technology.

Specifically, the diagram includes a ‘Processes to make it more efficient and streamline’ (block 1020), which is directly connected to the ‘Output’ block (block 1010) and is further elaborated upon by associated components such as ‘Process design documents’ and ‘Process explanation documents’. The ‘Process design documents’ sub-block may include receiving tangible documentation that outlines the design of the processes, whereas the ‘Process explanation documents’ sub-block indicates the presence of materials that provide explanations for these processes.

Adjacent to block 1020 is a ‘People structure to make it more efficient’ (block 1030) that also draws from the ‘Output’ block (block 1010). This branch further divides into specific elements focused on the roles and responsibilities of people within the system, underscored by ‘People roles & responsibilities’, ‘Job descriptions, business use case’, and ‘Compensation documents’. These blocks show that the subprocess includes defining roles, providing clear job descriptions that align with business cases, and establishing compensation strategies which are documented.

Furthermore, the flowchart features a ‘Technology to make it more efficient’ (block 1040) that links back to the ‘Output’ block (block 1010). Block 1040 is the starting point for additional details that include ‘Architecture design documents’ and ‘Architecture explanation’. These elements demonstrate that technological efficiency is supported by thorough documentation that details the design of the technological architecture and materials that explain this design.

The output of the subprocess at block 1010 corresponds to the output 940 of FIG. 9, which represents the final output of the preceding subprocess. This connection indicates that the output generated from the AI components in FIG. 9 serves as an input for the efficiency and streamlining strategies depicted in FIG. 10.

The diagram of FIG. 10 conceptually maps the transition from the initial output through various efficiency-improving subprocesses dealing with process optimization, human resource structuring, and technology enhancement. This progression reflects the ability of the system 200 to utilize the output from complex AI analyses to further refine and optimize the overall system performance. The detailed structure of this diagram emphasizes the systematic approach toward continuous improvement in process execution, workforce organization, and technological frameworks, fostering the creation of comprehensive strategies in a methodical and integrated fashion.

The AI-Enabled Organizational Redesigner System 200, as depicted in FIG. 2, represents a comprehensive solution for managing and supporting the complex process of organizational redesign. This system is designed to integrate inputs from various aspects of an organization, including the current people, process, and technology landscapes, as well as industry knowledge and regional rules and policies. By leveraging artificial intelligence, the system intelligently synthesizes these inputs to facilitate a holistic and informed organizational redesign.

In operation, the system begins by gathering foundational inputs about the organization's current state. This includes information on the current people landscape, which is informed by organization charts, HR documents, and compensation documents to identify future reorganization needs, skill sets, and roles. The process landscape is understood through process documents, SOPs, user flow documents, and business and functional requirement documents, enabling the identification of efficiency opportunities and gaps. The technology landscape is clarified by analyzing technical requirement documents, runbooks, playbooks, and code repositories to understand the current tech stack and architecture. These inputs are help the system 200 to create a technical layout for use in the redesign process.

Additionally, the system 200 interfaces with industry knowledge and regional rules and policies to ensure that the redesign is both industry-agnostic and compliant with regulatory requirements. This may be achieved by gathering and classifying information from the web, past documents, industry domain documents, and region-specific information about policies, rules, and regulations.

User input may be used in the system, for example, as collected through an interactive chatbot-enabled platform. This allows for the understanding of objectives, goals, and key parameters for the redesign, ensuring that stakeholder preferences and feedback are incorporated into the process.

The intelligent designer 207 may synthesize all the collected inputs to craft the organizational redesign by employing Generative AI models to synthesize and map user inputs to scenarios needed for redesigning the organization. In some aspects, the system 200 employs a continuous learning model with human in the loop for ongoing improvement, ensuring that the redesign remains relevant and effective over time.

The output of the system, i.e., the org redesign 208, may include process design documents, changes in people structure, job descriptions, compensation documents, and architecture design documents. This output provides a detailed overview of the redesigned organization, including a new org chart with updated roles and responsibilities.

The ability of the system 200 to perform data collection in an automated way, coupled with the use of Generative AI models, enables a few individuals to shape the redesign based on available data. This approach not only streamlines the redesign process but also ensures that the final product is optimized based on various inputs and intelligent processing. The AI-Enabled Organizational Redesigner System 200 represents a sophisticated tool for facilitating organizational redesign. By integrating inputs from different organizational landscapes and leveraging AI for synthesis and decision support, the system offers a holistic and informed approach to organizational redesign, ensuring that the final design is optimized, compliant, and reflective of stakeholder preferences.

The AI-Enabled Organizational Redesigner System 200 leverages a sophisticated computing architecture designed to automate and streamline the process of organizational redesign. This system integrates various components, each dedicated to understanding and optimizing different aspects of an organization, including its people, processes, and technology landscapes. The core of the system is powered by Generative AI (GenAI) models, neural network models, and Generative Adversarial Networks (GANs), which work in tandem to synthesize inputs, recommend improvements, and generate detailed redesign recommendations.

The intelligent designer component (block 207) is the system's “brain”, synthesizing inputs from multiple sources to craft the organizational redesign. It is trained using a diverse set of data, including organization charts, HR documents, compensation documents, process documents, SOPs, business and functional requirement documents, technical requirement documents, runbooks, playbooks, code repositories, industry knowledge, and regional rules & policies. This training data is collected from existing organizational documents, industry websites, expert inputs, and domain-specific documents, ensuring the model is well-versed in various aspects of organizational structure, processes, and technology.

The training process involves leveraging past documents and experiences to understand the nuances of different industries and regions, ensuring the system's outputs are both industry-agnostic and compliant with regional regulations. For instance, the system is trained to recognize and incorporate specific requirements for data residency in Europe, ensuring compliance with local regulations. This training approach enables the intelligent designer to intelligently craft organizational redesigns that are optimized, compliant, and reflective of stakeholder preferences.

### Exemplary Computer-Implemented Stakeholder Preferences Matching

The system 200 may be configured to specifically match stakeholder preferences, in some aspects. For example, some the AI-Enabled Organizational Redesigner System 200 is designed to consider and incorporate the specific goals, objectives, requirements, and feedback of the stakeholders involved in the organizational redesign process. Stakeholders can include executives, managers, employees, and other parties interested in or affected by the redesign. The system 200 ensures that the final organizational design reflects these preferences, thereby increasing the likelihood of stakeholder buy-in and the successful implementation of the redesign. Exemplary stakeholder preferences may include whether to implement the organizational redesign as a phased or direct approach, introducing changes gradually to minimize disruption. Others might favor a direct approach, implementing all changes at once to quickly realize the redesign's benefits. The system 200 can tailor the redesign plan to accommodate the preferred implementation strategy.

Technology adoption preferences are another area in which stakeholder preferences may be expressed. For example, different stakeholders might have varying preferences for technology adoption based on their comfort level with new technologies, budget constraints, or strategic priorities. For instance, a stakeholder might prioritize integrating cloud computing solutions to enhance flexibility and scalability, while another might focus on cybersecurity measures. The system 200 can recommend technology enhancements that align with these preferences.

Regulatory compliance is yet another stakeholder preference area. For organizations operating in multiple regions, stakeholders in each region may have specific compliance requirements that need to be addressed in the redesign. For example, stakeholders in Europe may emphasize compliance with GDPR for data protection, while those in the United States may focus on HIPAA compliance in healthcare operations. The system 200 can ensure that the redesign meets these region-specific regulatory requirements.

Stakeholder preferences may include industry-specific needs, in some aspects. Stakeholders from different industries may have unique needs and preferences based on industry standards, competitive pressures, and customer expectations. For example, stakeholders in the financial services industry may prioritize secure and efficient transaction processing systems, while those in the manufacturing sector may focus on optimizing supply chain logistics. The system 200 can incorporate industry-specific knowledge to meet these needs.

Finally, organizational culture and values are often inextricably linked with stakeholder preferences, related to preserving certain aspects of the organization's culture and values during the redesign. For instance, maintaining a culture of innovation, collaboration, or customer-centricity may be a priority. The system 200 can recommend organizational structures and processes that support and enhance these cultural attributes.

By collecting user input and synthesizing this input with other data, the AI-Enabled Organizational Redesigner System 200 ensures that the redesign recommendations are closely aligned with stakeholder preferences. This alignment is crucial for ensuring that the redesign is not only effective in achieving its objectives but also accepted and supported by those it affects.

This computing architecture enables the system 200 to efficiently process and analyze vast amounts of data, leveraging AI to facilitate am informed organizational redesign. By integrating inputs from different organizational landscapes and employing AI methodologies, the system offers a powerful tool for optimizing organizational structures, processes, and technology deployments. As discussed in the next section, the training of the AI-Enabled Organizational Redesigner System 200, particularly its intelligent designer component and associated AI models, may be multi-faceted, and may include synthesizing inputs, recommending improvements, and generating detailed redesign recommendations that are both practical and aligned with organizational goals.

### Exemplary Computing Architectures

The computing architecture of system 200 is designed to support the complex processing and analysis required by the intelligent designer and its subcomponents. It may comprise a distributed computing environment capable of handling large volumes of data and executing sophisticated AI and machine learning algorithms. The computing architecture may include data collection and preprocessing instructions that automate the collection of input data from various sources, including manual inputs and automated data feeds. These instructions may preprocess the data for analysis, structuring it in a format suitable for the AI models. The Generative AI Models included in the system 200 synthesize inputs from the data collection units to understand the current state of the organization's people, processes, and technology landscapes, and may be trained on domain-specific data to ensure accuracy and relevance in their output.

The neural network models included in the system 200 may recommend patterns for process, people, and technology enhancements based on the synthesized inputs, and may be trained using a combination of supervised and unsupervised learning techniques to identify optimal redesign strategies.

The generative adversarial networks (GANs) may be used to generate detailed redesign recommendation reports. They refine the outputs of the neural network models, ensuring the recommendations are practical and actionable.

As noted, the system 200 may employ a continuous learning model with human in the loop, allowing for ongoing improvement based on feedback and new data. This ensures the system remains up-to-date and relevant over time. The system 200 may also include a user interaction interface, in some aspects. This interface may be an interactive chatbot-enabled platform that collects user inputs, clarifying objectives, goals, and key parameters for the redesign. This ensures the system's outputs align with stakeholder preferences, as discussed above.

### Exemplary Computer-Implemented Machine Learning Model Training Processes

For example, a computer-implemented method for machine learning training may include data collection and curation, data preprocessing, model training, continuous learning/feedback integration, and performance evaluation and optimization.

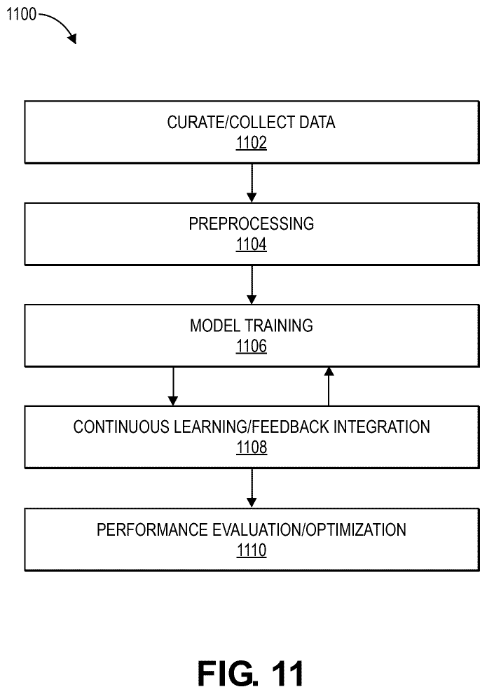

FIG. 11 depicts a computer-implemented method 1100 depicting these steps. In some aspects, the training method 1100 may include collecting and curating a diverse set of data that reflects various aspects of organizational structures, processes, technology landscapes, industry knowledge, and regional regulations (block 1102). This data may include, but is not limited to: organization charts, HR documents, and compensation documents to understand the people landscape; process documents, SOPs, business, and functional requirement documents for insights into the process landscape; technical requirement documents, runbooks, playbooks, and code repositories to grasp the technology landscape; industry-specific documents, expert inputs, and regional rules & policies to ensure industry relevance and regulatory compliance.

Once collected, the method 1100 may include preprocessing the collected data to transform it into a format suitable for AI model training (block 1104). This step may involve cleaning the data to remove inaccuracies or irrelevant information, normalizing data formats, and segmenting the data into training, validation, and test sets. The preprocessing also includes labeling the data where necessary, especially for supervised learning components of the training.

The training method 1100 may include training one or more Generative AI models, neural network models, and/or Generative Adversarial Networks (GANs) using the preprocessed data (block 1106). Block 1106 may be executed in several sub-steps. For example, to train a Generative AI Model, block 1106 may include training the model to synthesize inputs from the collected data, learning to understand the current state of the organization's people, processes, and technology landscapes. The training may include unsupervised learning or semi-supervised learning, where the model learns to identify patterns and relationships in the data without explicit labeling.

To train a neural network model, block 1106 may include training one or more models to recommend patterns for process, people, and technology enhancements. The training may include supervised learning, where the model learns from labeled examples to predict outcomes based on input data. The models are trained to recognize efficient organizational structures, process optimizations, and technology deployment strategies.

To train one or more GANs, block 1106 may include generating detailed redesign recommendation reports. The training may include two models: a generator that creates recommendations and a discriminator that evaluates their quality. Through iterative training, the generator learns to produce increasingly accurate and realistic recommendations.

In some aspects, the method 1100 may include performing continuous learning and feedback integration (block 1108). For example, a continuous learning loop may be established to allow the system 200 to learn from new data and feedback continuously. This involves retraining the models periodically with new data collected from ongoing organizational redesigns, user feedback, and changes in industry practices or regulations. Human-in-the-loop mechanisms may be employed to review model recommendations and provide corrective feedback, which is then used to further refine the models.

In some aspects, the method 1100 may include performance evaluation and optimization (block 1110). Throughout the training process, the performance of the AI models may be continuously evaluated using metrics relevant to each model's objectives, such as accuracy, precision, recall, and F1 score for classification tasks, or mean squared error for regression tasks. The models are optimized based on these evaluations, adjusting model parameters, and training approaches to improve performance. The training process for the AI-Enabled Organizational Redesigner system 200 may be iterative and ongoing, ensuring that the system remains effective, up-to-date, and capable of delivering optimized organizational redesign recommendations.

### Exemplary Language Model Architecture

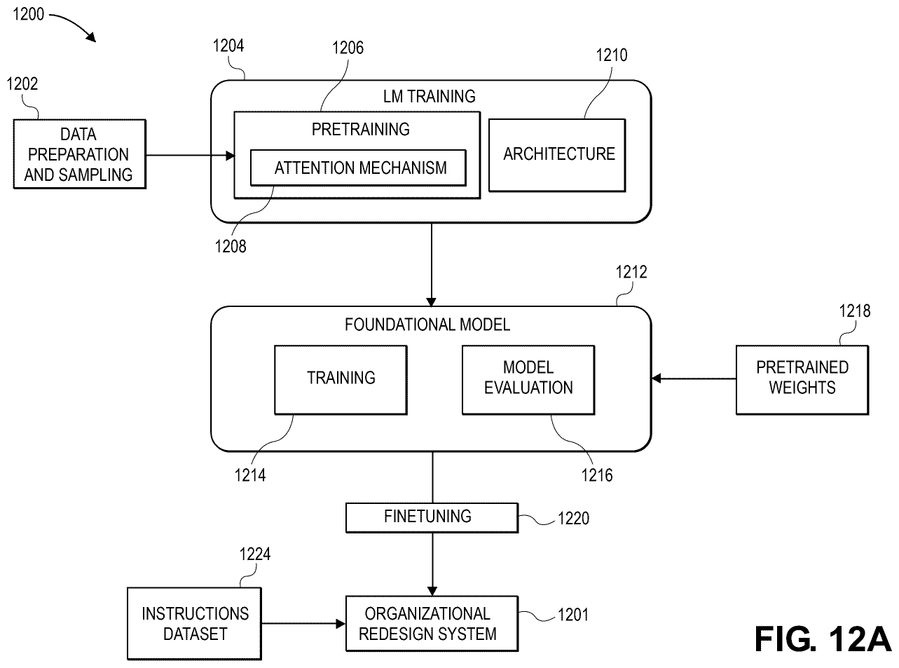

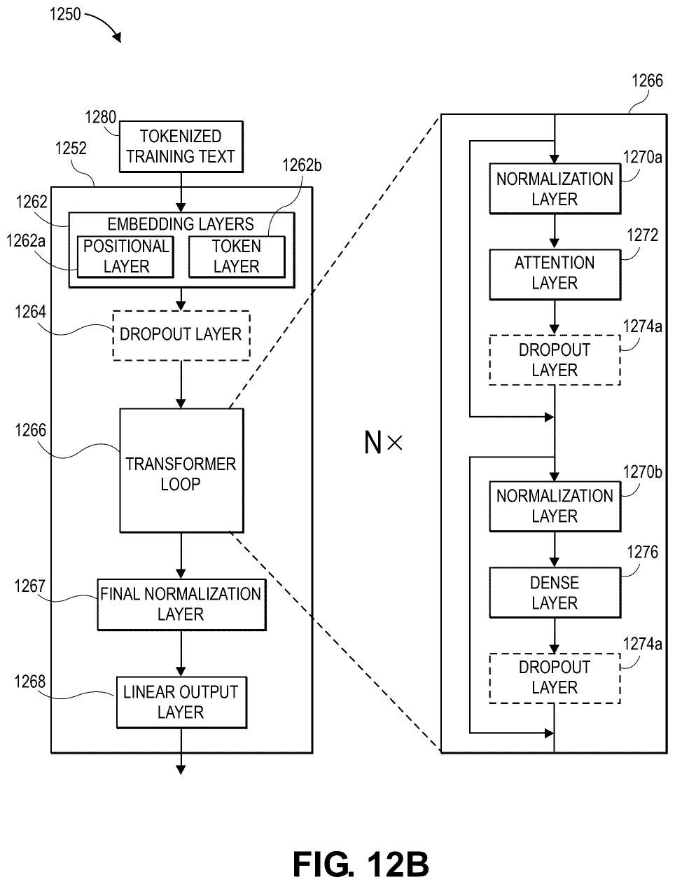

FIG. 12A depicts a block-flow diagram 1200 of a method and system designed to facilitate organizational redesign through analysis and phased implementation based on user input and current models. In some aspects, the system may correspond to the system 100 of FIG. 1 and/or the system 200 of FIG. 2. The block-flow diagram 1200 begins with data preparation and sampling (block 1202), which is used by the model to understand the current organizational structure and identifying areas for improvement. This step feeds into the language model (LM) training phase (block 1204), which is divided into pretraining (block 1206), where attention mechanisms are focused on (block 1208), and architecture development (block 1210), under the overarching process of LM training.

Following the LM training, the process advances to the foundation model phase (block 1212), which includes further training (block 1214) and model evaluation (block 1216). This phase may refine the model based on the initial training to ensure its effectiveness and accuracy. In some aspects, the foundation model may be provided with pretrained weights (block 1218). This may greatly accelerate the model training process (e.g., via transfer learning).

The block-flow diagram further includes finetuning (block 1220), where the foundation model may be adjusted and optimized using further data (e.g., specific organizational redesign data, as described above). The finetuning at block 1220 advantageously enables tailoring the model to meet the unique needs and objectives of the organization.

Additionally, the block-flow diagram includes an instructions dataset (block 1224), which feeds into the organizational redesign system (block 1201). The instructions dataset may include one or more prompts for the LM that enable specific analyses/responses to be elicited from the trained model, to facilitate the practical application of the trained model in organizational contexts.

FIG. 12B illustrates a transformer-based model architecture for processing tokenized training text (block 1252). The process begins with tokenized training text (block 1280) which is then passed through embedding layers, specifically a positional layer (block 1262a) and a token layer (block 1262b). These layers are followed by a dropout layer (block 1264) to prevent overfitting. The core of the architecture is the transformer loop (block 1266), which is iterated N times, where N is a positive integer. Each iteration consists of a normalization layer (block 1270a), followed by an attention layer (block 1272) with its own dropout layer (block 1274a), another normalization layer (block 1270b), a dense layer (block 1276), and another dropout layer (block 1274b). The process concludes with a final normalization layer (block 1267) and a linear output layer (block 1268), producing the final output from the transformer-based model. This architecture is designed to handle and transform tokenized text data for natural language processing tasks.

The model architecture depicted in FIG. 12B may be used to train the language models (LMs) discussed herein, particularly in the context of organizational redesign. This transformer-based architecture facilitates the processing of tokenized training text through a series of layers and loops designed to understand and generate language patterns effectively. Initially, the tokenized training text is processed through embedding layers, including positional and token layers, which help the model understand the context and significance of each word or token within a sentence. This is crucial for language models as it allows them to grasp the nuances of language, including syntax and semantics, which are essential for generating meaningful and contextually relevant text. The dropout layers introduced after the embedding layers and within the transformer loop serve to prevent overfitting by randomly omitting some of the units from the layers during training. This ensures that the model does not become too reliant on the training data, allowing it to generalize better to new, unseen data. The transformer loop, iterated N times, is where the bulk of the processing happens. Each iteration consists of a series of layers including normalization, attention, and dense layers, each followed by dropout layers. The normalization layers help stabilize the learning process, while the attention layers allow the model to focus on different parts of the input text to better understand the relationships between words. The dense layers, on the other hand, are fully connected layers that help in learning non-linear combinations of the features. The final normalization layer ensures that the data is normalized before passing it to the linear output layer, which produces the final output of the model. This output can then be used for various natural language processing tasks relevant to organizational redesign, such as generating text that maps user inputs to specific redesign scenarios, as discussed above. In the context of organizational redesign, the trained language models can analyze current organizational models, including people, process, and technology landscapes, and generate recommendations for organizational maturity and design future state ecosystems. By leveraging the transformer-based architecture, the models can understand and synthesize complex organizational data, user inputs, and industry knowledge to output strategic and data-driven redesign plans. This process is facilitated by the model's ability to learn from vast amounts of data, identify patterns, and generate coherent and contextually relevant text that aligns with the objectives of the organizational redesign.

It should be appreciated that other architectures could be used instead of transformers in FIG. 12B for training language models (LMs), such as one or more recurrent neural networks (RNNs), one more long short-term memory networks (LSTMs), and/or one or more convolutional neural networks (CNNs) specifically designed for sequence processing tasks. Each of these architectures has unique characteristics that make them suitable for different aspects of natural language processing (NLP). It should also be appreciated that in some aspects, achieving the result of FIG. 12A without pretraining a foundational model and/or without fine-tuning could be possible, albeit perhaps not as effective/efficient, especially for complex tasks like organizational redesign. Pretraining on large datasets allows the model to learn a wide range of language features and general knowledge about the world, which can then be fine-tuned to specific tasks or domains with relatively smaller datasets. This two-step approach leverages the benefits of both broad and specialized learning, often leading to better performance on the target task. However, for certain applications or in scenarios where large-scale pretraining is not feasible due to resource constraints, it might be possible to train a model directly on task-specific data from scratch. The effectiveness of this approach would depend on the complexity of the task, the amount and quality of the task-specific data available, and the capacity of the chosen model architecture. In such cases, simpler models or those architectures mentioned above might be employed, potentially sacrificing some level of performance or generalizability achieved through the pretraining and fine-tuning approach.

### Aspects

The various embodiments described above can be combined to provide further embodiments. All U.S. patents, U.S. patent application publications, U.S. patent application, foreign patents, foreign patent application and non-patent publications referred to in this specification and/or listed in the Application Data Sheet are incorporated herein by reference, in their entirety. Aspects of the embodiments can be modified if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims but should be construed to include all possible embodiments along with the full scope of equivalents to which such claims are entitled. Accordingly, the claims are not limited by the disclosure.

Aspects of the techniques described in the present disclosure may include any of the following aspects, either alone or in combination:
1. A computing system comprising: a processor; and a memory having stored thereon computer-executable instructions that, when executed, cause the computing system to: receive user input regarding organizational redesign objectives and parameters; analyze current organizational models including people, process, and technology landscapes; generate recommendations for organizational maturity and design future state ecosystems that are secure, lean, scalable, and meet customer needs; and output a redesign plan for the organization in a phased approach based on the analysis and recommendations.
2. The computing system of aspect 1, further comprising instructions that, when executed, cause the computing system to: interact with users through a chatbot-enabled platform to collect detailed user inputs.
3. The computing system of any of aspects 1-2, further comprising instructions that, when executed, cause the computing system to: use one or more generative AI models to synthesize and map user inputs to specific redesign scenarios.
4. The computing system of any of aspects 1-3, further comprising instructions that, when executed, cause the computing system to: analyze existing people landscape using organization charts, HR documents, and compensation data to identify skill gaps and roles for future organizational structure.
5. The computing system of any of aspects 1-4, further comprising instructions that, when executed, cause the computing system to: analyze existing process landscapes using process flow documents, SOPs, and business requirements to identify opportunities for efficiency improvements and automation.
6. The computing system of any of aspects 1-5, further comprising instructions that, when executed, cause the computing system to: analyze existing technology landscapes using technical requirement documents, runbooks, and architecture diagrams to understand current tech stacks and identify areas for technological advancement.
7. The computing system of any of aspects 1-6, further comprising instructions that, when executed, cause the computing system to: incorporate industry-specific knowledge and regional compliance requirements into the redesign plan to ensure adherence to relevant policies and regulations.
8. A computer-implemented method comprising: receiving user input regarding organizational redesign objectives and parameters; analyzing current organizational models including people, process, and technology landscapes; generating recommendations for organizational maturity and design future state ecosystems that are secure, lean, scalable, and meet customer needs; and outputting a redesign plan for the organization in a phased approach based on the analysis and recommendations.
9. The method of aspect 8, further comprising: interacting with users through a chatbot-enabled platform to collect detailed user inputs.
10. The method of any of aspects 8-9, further comprising: using one or more generative AI models to synthesize and map user inputs to specific redesign scenarios.
11. The method of any of aspects 8-10, further comprising: analyzing existing people landscape using organization charts, HR documents, and compensation data to identify skill gaps and roles for future organizational structure.
12. The method of any of aspects 8-11, further comprising: analyzing existing process landscapes using process flow documents, SOPs, and business requirements to identify opportunities for efficiency improvements and automation.
13. The method of any of aspects 8-12, further comprising: analyzing existing technology landscapes using technical requirement documents, runbooks, and architecture diagrams to understand current tech stacks and identify areas for technological advancement.
14. The method of any of aspects 8-13, further comprising: incorporating industry-specific knowledge and regional compliance requirements into the redesign plan to ensure adherence to relevant policies and regulations.
15. A computer-readable medium having stored thereon instructions that when executed cause a computer to: receive user input regarding organizational redesign objectives and parameters; analyze current organizational models including people, process, and technology landscapes; generate recommendations for organizational maturity and design future state ecosystems that are secure, lean, scalable, and meet customer needs; and output a redesign plan for the organization in a phased approach based on the analysis and recommendations.
16. The computer-readable medium of aspect 15, further comprising instructions that, when executed, cause the computer to: interact with users through a chatbot-enabled platform to collect detailed user inputs.
17. The computer-readable medium of any of aspects 15-16, further comprising instructions that, when executed, cause the computer to: use one or more generative AI models to synthesize and map user inputs to specific redesign scenarios.
18. The computer-readable medium of any of aspects 15-17, further comprising instructions that, when executed, cause the computer to: analyze existing people landscape using organization charts, HR documents, and compensation data to identify skill gaps and roles for future organizational structure.
19. The computer-readable medium of any of aspects 15-18, further comprising instructions that, when executed, cause the computer to: analyze existing process landscapes using process flow documents, SOPs, and business requirements to identify opportunities for efficiency improvements and automation.
20. The computer-readable medium of any of aspects 15-19, further comprising instructions that, when executed, cause the computer to: incorporate industry-specific knowledge and regional compliance requirements into the redesign plan to ensure adherence to relevant policies and regulations.

### Additional Considerations

The following considerations also apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

It should also be understood that, unless a term is expressly defined in this patent using the sentence “As used herein, the term” “is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112(f).

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,”“having”or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for implementing the concepts disclosed herein, through the principles disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computing system comprising:
a processor; and
a memory having stored thereon computer-executable instructions that, when executed, cause the computing system to:
receive user input regarding organizational redesign objectives and parameters;
analyze current organizational models including people, process, and technology landscapes;
generate recommendations for organizational maturity and design future state ecosystems that are secure, lean, scalable, and meet customer needs; and
output a redesign plan for the organization in a phased approach based on the analysis and recommendations.

2. The computing system of claim 1, further comprising instructions that, when executed, cause the computing system to:
interact with users through a chatbot-enabled platform to collect detailed user inputs.

3. The computing system of claim 1, further comprising instructions that, when executed, cause the computing system to:
use one or more generative AI models to synthesize and map user inputs to specific redesign scenarios.

4. The computing system of claim 1, further comprising instructions that, when executed, cause the computing system to:
analyze existing people landscape using organization charts, HR documents, and compensation data to identify skill gaps and roles for future organizational structure.

5. The computing system of claim 1, further comprising instructions that, when executed, cause the computing system to:
analyze existing process landscapes using process flow documents, SOPs, and business requirements to identify opportunities for efficiency improvements and automation.

6. The computing system of claim 1, further comprising instructions that, when executed, cause the computing system to:
analyze existing technology landscapes using technical requirement documents, runbooks, and architecture diagrams to understand current tech stacks and identify areas for technological advancement.

7. The computing system of claim 1, further comprising instructions that, when executed, cause the computing system to:
incorporate industry-specific knowledge and regional compliance requirements into the redesign plan to ensure adherence to relevant policies and regulations.

8. A computer-implemented method comprising:
receiving user input regarding organizational redesign objectives and parameters;
analyzing current organizational models including people, process, and technology landscapes;
generating recommendations for organizational maturity and design future state ecosystems that are secure, lean, scalable, and meet customer needs; and
outputting a redesign plan for the organization in a phased approach based on the analysis and recommendations.

9. The method of claim 8, further comprising:
interacting with users through a chatbot-enabled platform to collect detailed user inputs.

10. The method of claim 8, further comprising:
using one or more generative AI models to synthesize and map user inputs to specific redesign scenarios.

11. The method of claim 8, further comprising:
analyzing existing people landscape using organization charts, HR documents, and compensation data to identify skill gaps and roles for future organizational structure.

12. The method of claim 8, further comprising:
analyzing existing process landscapes using process flow documents, SOPs, and business requirements to identify opportunities for efficiency improvements and automation.

13. The method of claim 12, further comprising:
analyzing existing technology landscapes using technical requirement documents, runbooks, and architecture diagrams to understand current tech stacks and identify areas for technological advancement.

14. The method of claim 13, further comprising:
incorporating industry-specific knowledge and regional compliance requirements into the redesign plan to ensure adherence to relevant policies and regulations.

15. A computer-readable medium having stored thereon instructions that when executed cause a computer to:
receive user input regarding organizational redesign objectives and parameters;
analyze current organizational models including people, process, and technology landscapes;
generate recommendations for organizational maturity and design future state ecosystems that are secure, lean, scalable, and meet customer needs; and
output a redesign plan for the organization in a phased approach based on the analysis and recommendations.

16. The computer-readable medium of claim 15, further comprising instructions that, when executed, cause the computer to:
interact with users through a chatbot-enabled platform to collect detailed user inputs.

17. The computer-readable medium of claim 15, further comprising instructions that, when executed, cause the computer to:
use one or more generative AI models to synthesize and map user inputs to specific redesign scenarios.

18. The computer-readable medium of claim 15, further comprising instructions that, when executed, cause the computer to:
analyze existing people landscape using organization charts, HR documents, and compensation data to identify skill gaps and roles for future organizational structure.

19. The computer-readable medium of claim 15, further comprising instructions that, when executed, cause the computer to:
analyze existing process landscapes using process flow documents, SOPs, and business requirements to identify opportunities for efficiency improvements and automation.

20. The computer-readable medium of claim 15, further comprising instructions that, when executed, cause the computer to:
incorporate industry-specific knowledge and regional compliance requirements into the redesign plan to ensure adherence to relevant policies and regulations.
